(19) United States
(12) Patent Application Publication
(10) Pub. No.: US 2019/0070508 A1
(43) Pub. Date: Mar. 7, 2019

(54) ONLINE GOLF GAME CONTEMPERANOUS WITH LIVE GOLF TOURNAMENTS

(71) Applicant: Kevin Walter Cotton, Mason, OH (US)

(72) Inventor: Kevin Walter Cotton, Mason, OH (US)

(21) Appl. No.: 16/116,857

(22) Filed: Aug. 29, 2018

Related U.S. Application Data
(60) Provisional application No. 62/553,760, filed on Sep. 1, 2017.

(51) Int. Cl. A63F 13/65; A63F 13/573; A63F 13/798; A63F 13/46; A63F 13/533; A63F 13/812

(52) U.S. Cl. CPC A63F 13/65; A63F 13/573; A63F 13/798; A63F 2300/5553; A63F 13/533; A63F 13/812; A63F 13/46

(57) ABSTRACT

A gaming system for the contemporaneous viewing of a golf broadcast and the virtual playing of the same golf course including a player window adapted for the playing of virtual golf by a virtual player and a broadcast window adapted for the showing of golf being played by a non-virtual player. The player window and the broadcast window being adapted for the contemporaneous playing of the same golf course by the virtual player and the non-virtual player.

### FIELD OF THE DISCLOSURE

A gaming system for the contemporaneous viewing of a golf broadcast and the virtual playing of the same golf course.

### BACKGROUND

The golf industry is in a bit of a crisis. Since the early 2000s, the total number of golfers has steadily declined. The total number of golf rounds being played has declined. Viewership of PGA Tour events has declined and the next generation of golfers and viewers has yet to be found. The younger generations would rather play video games than play golf outside for real. The solution to help revive interest in golf for now and into the future is PGA Virtual Tour. This revolutionary concept will bring today's gamers to golf in a very unique way.

### SUMMARY

A gaming system for the contemporaneous viewing of a golf broadcast and the virtual playing of the same golf course, including a player window adapted for the playing of virtual golf by a virtual player and a broadcast window adapted for the showing of golf being played by a non-virtual player. The player window and the broadcast window being adapted for the contemporaneous playing of the same golf course by the virtual player and the non-virtual player. The gaming system may have a player window that includes a profile panel to enable a virtual player to customize their gaming experience. The profile panel may include an apparel window to enable a virtual player to customize the virtual clothes, shoes and the like. The profile panel may include a style window to enable a virtual player to customize the swing speed, ball trajectory, draw or fade preferences and the like. The profile panel may include a statistics window to enable a virtual player to review their personal stats related fairways in regulation, greens in regulation, average driving distance, putts per round and other like statistics. The profile panel may include a statistics window to enable a virtual player to review the stats of the non-virtual player related fairways in regulation, greens in regulation, average driving distance, putts per round and other like statistics. The profile panel may include an equipment selection window to enable a virtual player to select type of clubs, brand of clubs, type of balls, compression of balls, woods and lofts for each wood, irons and lofts for each iron, wedges type and lofts for each wedge, putter and loft, and other like equipment options.

The gaming system may also include a playing conditions panel to illustrate the actual playing conditions of the golf course being by the non-virtual player. The playing conditions are simulated in the virtual game. The gaming system may also include a virtual leaderboard that includes the scores of non-virtual players and virtual players. The gaming system may also include a commentator window wherein a broadcaster comments on the contemporaneous play of the virtual player and non-virtual player. The gaming system may also include a PGA hole window that shows the broadcast of the PGA golfing tournament. The gaming system may also include a screen swap button that allows for the swapping of the PGA hole window and a virtual hole window to toggle between a large screen and a small screen within the gaming display.

The gaming system may also include a golf avatar to digitally represent the virtual player within a screen of the contemporaneous broadcast of the non-virtual player. It may also include a second golf avatar to digitally represent a second virtual player within a screen of the contemporaneous broadcast of the non-virtual player.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 shows an exemplary logo for the PGA Virtual Tour game in accordance with the present invention;

FIG. 2 shows an exemplary list of different gaming devices that can be used to play the game contemplated within the present invention;

FIG. 3 shows an exemplary list of customizable features while playing the game;

FIG. 4 shows an exemplary gaming display wherein a user can edit their playing profile;

FIG. 5 shows an exemplary gaming display having a broadcasting window containing an actual tournament being played and also a virtual hole window containing a virtual player playing contemporaneously with the tournament being played;

FIG. 6 shows an exemplary gaming display similar to FIG. 5 with the broadcasting window and virtual hole window being toggled to make the virtual hole window larger in view;

FIG. 7 shows an exemplary virtual leaderboard that combines the scores of live PGA Tour players and also PGA Virtual players;

FIG. 8 shows an exemplary gaming display wherein a commentator window is shown and the commentators speak about the play of live PGA Tour event players and PGA Virtual players;

FIG. 9 shows an exemplary gaming display wherein an avatar of the virtual player is superimposed into the live broadcast of the live PGA tournament; and

FIG. 10 shows an exemplary gaming display wherein the virtual player may select from a variety of avatars.

### DETAILED DESCRIPTION

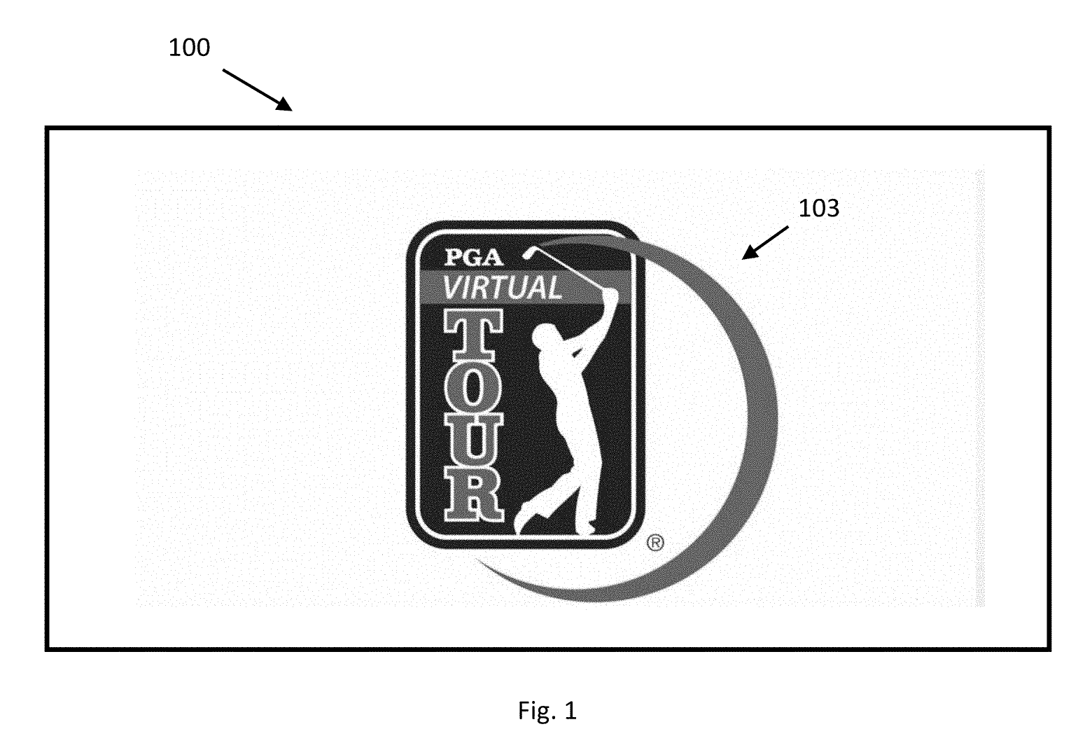

FIG. 1 shows an exemplary gaming display 100 for a PGA Virtual Tour game in accordance with the present invention. When a virtual player turns the game on, they may be greeted with an introductory logo such as game logo 103. This particular logo is a modification of the current PGA logo and maybe used with the permission of the PGA.

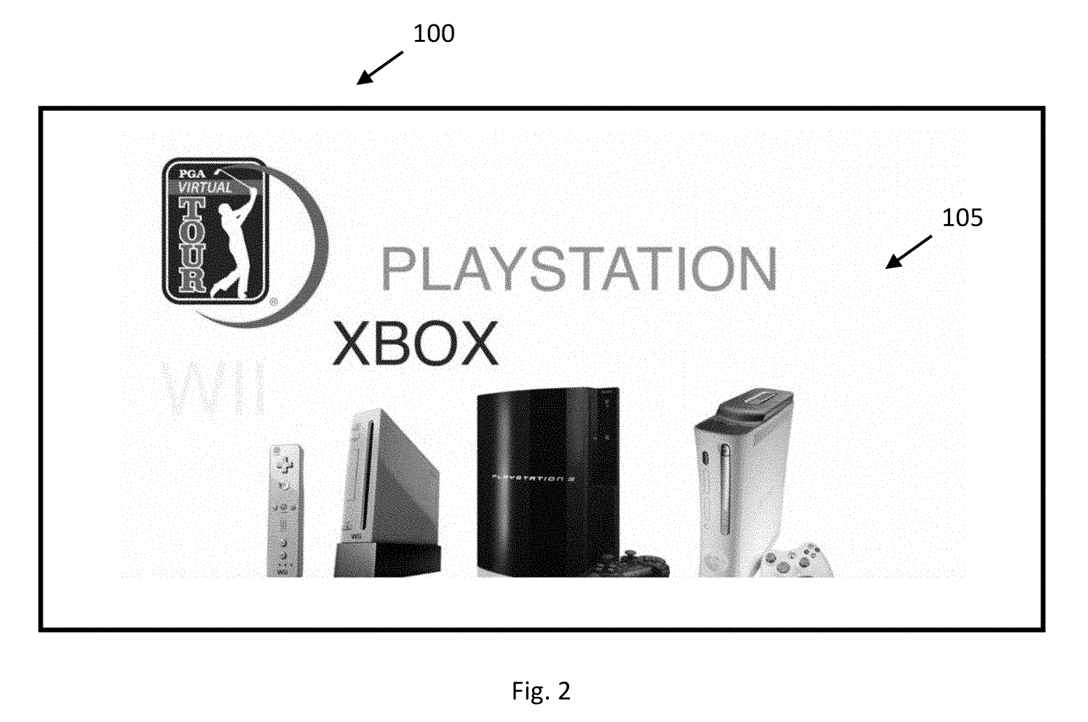

FIG. 2 shows an exemplary list of different gaming devices that can be used to play the game contemplated within the present invention. A virtual player could choose to play the game on their computer, on an Xbox, Wii, PlayStation or virtually any gaming device. PGA Virtual, as this game may be called, can be developed to work across all the major gaming devices. The virtual player may play on their preferred gaming device 105 on the same golf course and under the same conditions each week as the official PGA Tour. The player may choose to play right alongside the PGA Tour players with tee times or play at their most convenient time. The player may compete against other online players and possibly win prizes. And while traditional gaming devices are shown, other gaming forms may be contemplated like portable gaming devices and smartphones. Additionally, the present invention may be appreciated in the form of larger gaming systems in arcades and virtual-reality playing systems wherein the virtual player may actually swing a golf club (not shown).

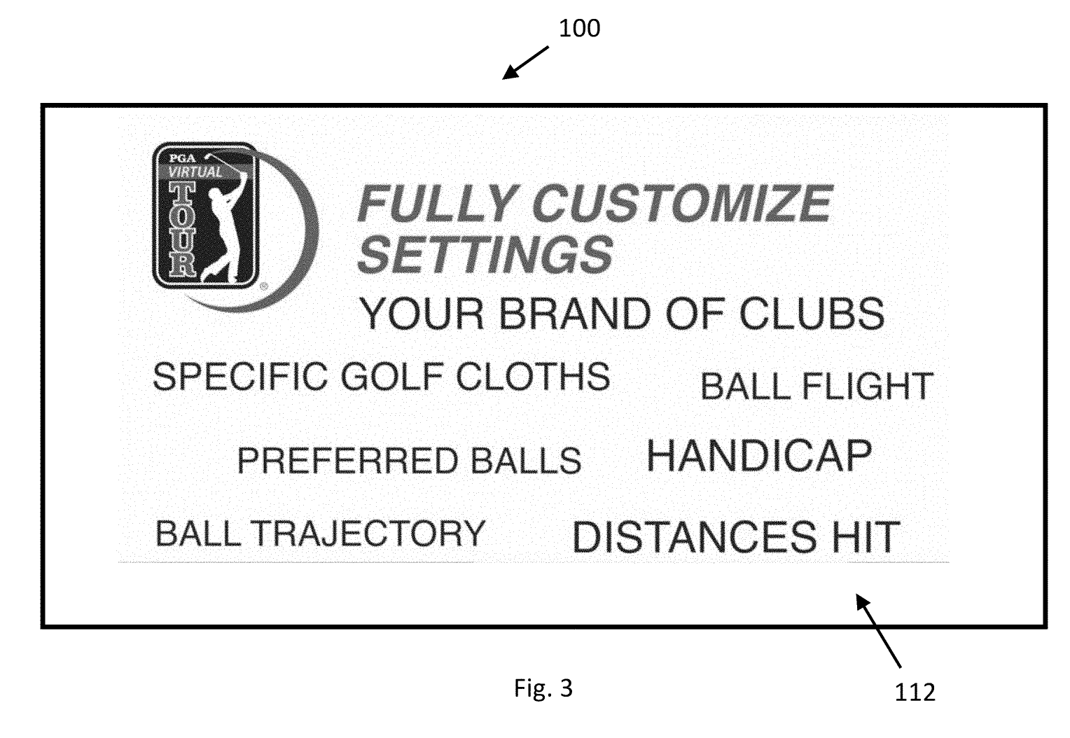

FIG. 3 shows an exemplary list of gaming variables 112 while playing the game. And while an exemplary list of gaming variables 112 are shown, many other variables may be contemplated to make the virtual experience as real as possible. Additionally, it may be desirable to offer new gaming variables as achievements during the game to encourage further play and achieved competencies. For example, is a virtual player wins a tournament or finishes in top 10, then perhaps they are rewarded with the option to customize their virtual clothing, or upgrade their clubs to a more expensive set, or hit their driver much further.

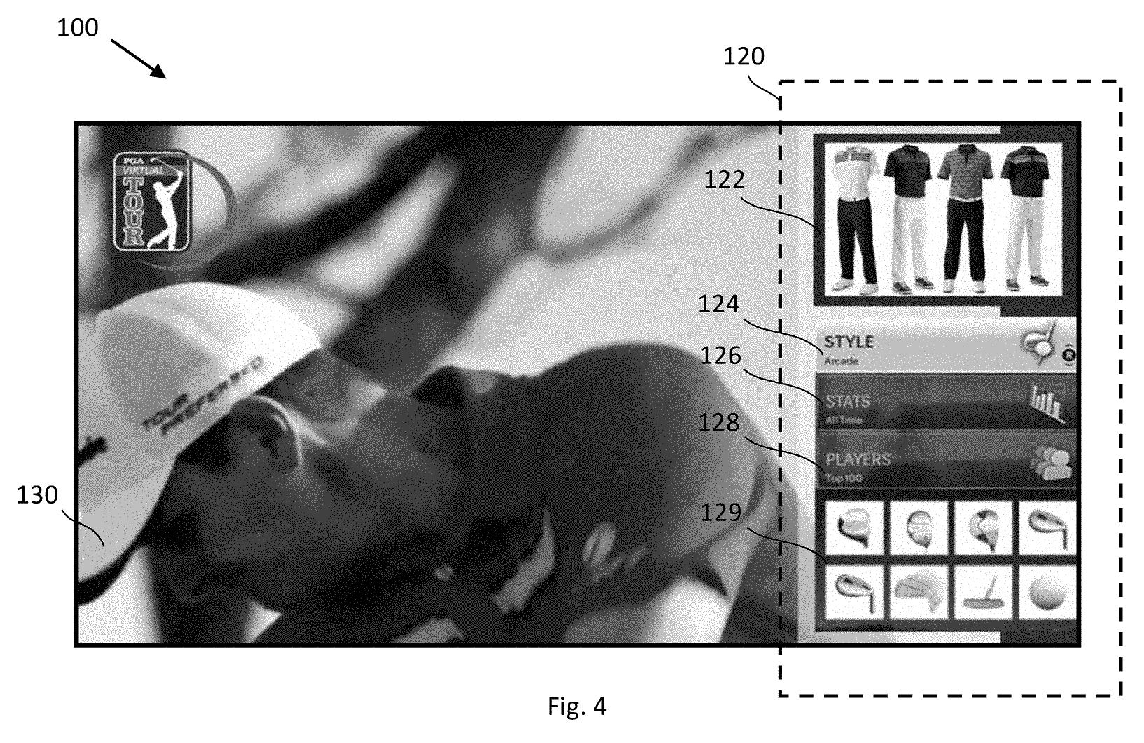

FIG. 4 shows an exemplary gaming display 100 wherein a user can edit their profile. In this exemplary display, a profile panel 120 is shown and allows the virtual player to select from a variety of playing options. For example, a virtual player can change their clothing in apparel window 122. A virtual player may also choose the style of play (e.g., swing speed, ball trajectory, draw or fade preferences) in a style window 124. A virtual player may review their personal stats (e.g., fairways in regulation, greens in regulation, average driving distance, putts per round), the stats of other virtual players and the stats of PGA players in statistics window 126. A virtual player may review the profiles, bios and accomplishments of various players in player window 128. A virtual player may choose from a variety of equipment selections within equipment selection window 129 (e.g., type of club, brand of club, type of ball, compression of ball, woods and lofts for each wood, irons and lofts for each iron, wedges type and lofts for each wedge, putter and loft, and many other options). Many of these choices will impact the ball flight and distance based on various playing conditions. Sophisticated algorithms may be built into the game of the present invention to calculate the various options selected by the virtual player and the actual playing conditions of the course for the given day.

The virtual player will enjoy selecting their favorite brand of pants, shirts, shoes and hat. In fact, actual brands (e.g., UnderArmor, Nike) may be incorporated and provide a source of advertising dollars for the gaming company. Further, the virtual player may choose to purchase the clothes while playing the game and have them mailed to them. In this way, the gaming system of the present invention may also provide a marketplace for virtual players to buy clothes and golf equipment. In an effort to match the clothing of a specific PGA player, as shown in broadcasting window 130, a virtual player may simply select the PGA player and their particular clothing and equipment may become immediately identified and ready for purchase by the virtual player.

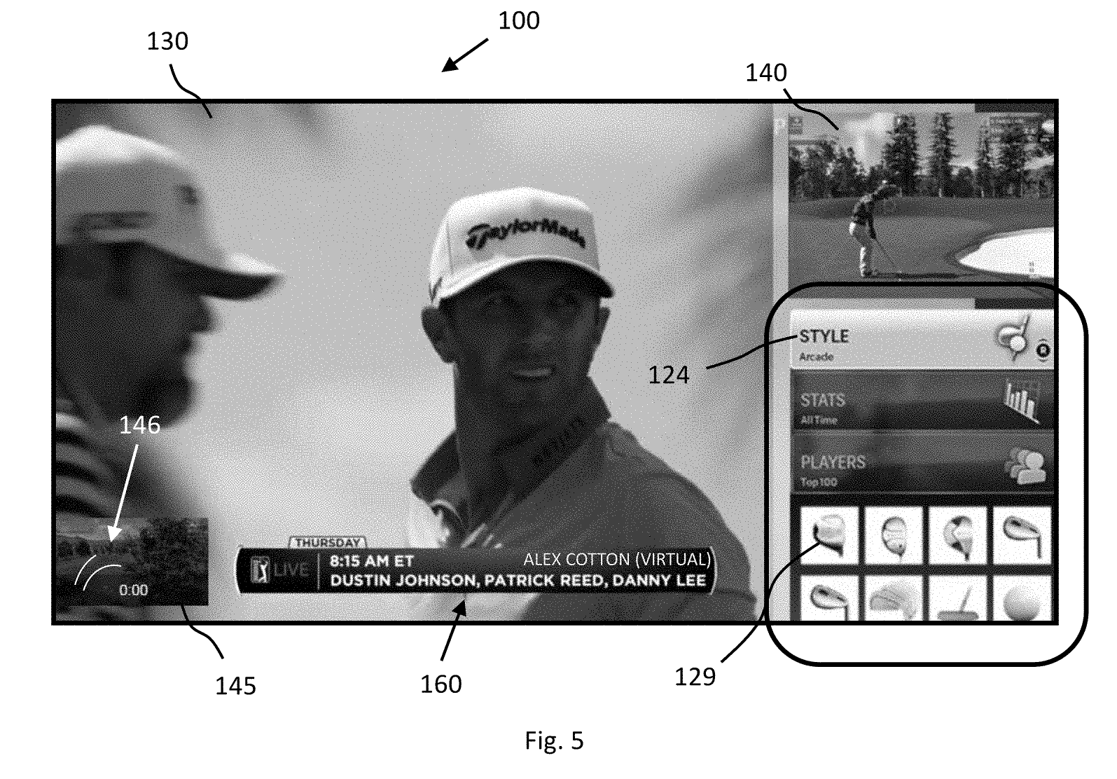

FIG. 5 shows an exemplary gaming display 100 wherein broadcasting window 130 is shown with a real PGA player playing golf. Virtual hole window 140 is shown wherein a virtual player may be playing the same hole as part of the same foursome, or alternatively, playing a different hole in a different foursome. Virtual tracker window 145 can be used to show the ball flight 146 of shots hit by various players from a bird's-eye view. Virtual tee time selector 160 shows how real PGA players and virtual players may be paired in the same tee times. Virtual players may be able to select from all tee times for the respective tournament and choose who they want to play with.

It may be desirable for the virtual player to be playing the same course, under the same conditions as the PGA Tour pros. The virtual player may play the game like a normal round of golf. The virtual player may choose a desired club from their bag for the appropriate shot. The conditions, wind, rain etc. may be the same as the live PGA Tour event. Wind speed and direction are displayed on the screen. When playing the hole, the virtual player may be able to scroll around in all directions to view the entire hole. The virtual player may also be given tee times alongside the PGA Touring Pros or they can choose to play at their own time. In playing the hole, the virtual player may play just like golf—they will hit their tee shot and the ball will travel based on their profile settings and all conditions. After their tee shot, the virtual player may see where they lie for their second shot and based on lie, distance and conditions, the player will choose their desired club for the next shot. This is how each hole will be played through the green. It may be desirable for the virtual player to play four rounds for each tournament event, just like the PGA Touring pros. At the end of the event, scores may be totaled and just like the PGA Touring Pros, virtual players may win prizes, including money. The sponsors for the PGA Tour event will also be providing the prizes/money for the PGA Virtual Tour.

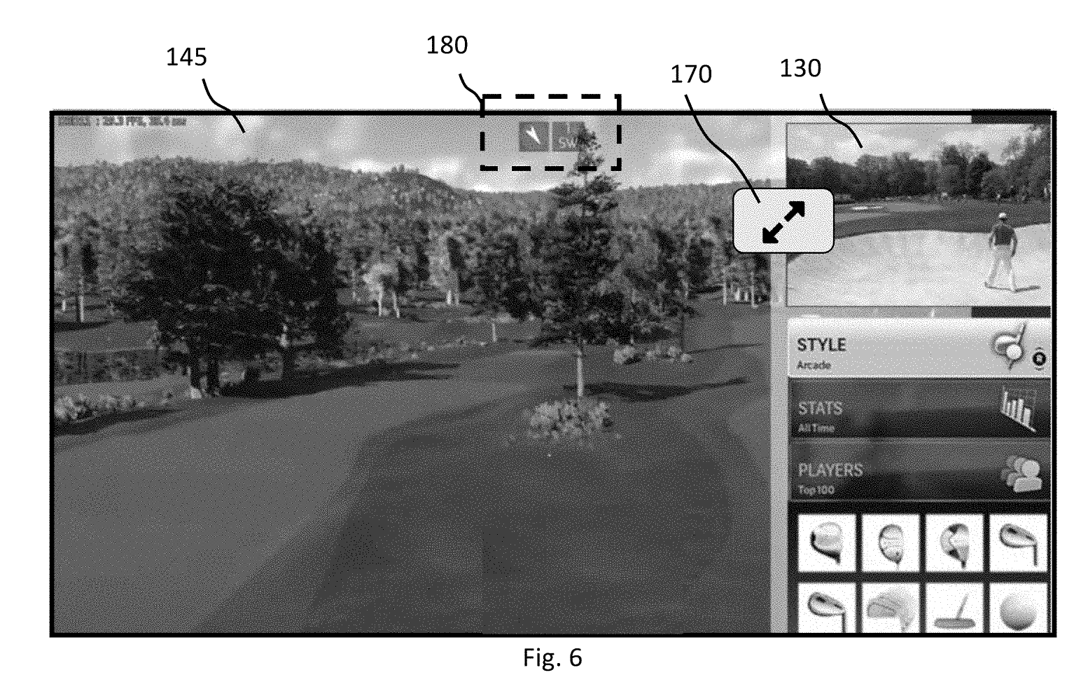

FIG. 6 shows a screen swap button 170 wherein the virtual tracker window 145 may be viewed in the larger screen portion and the broadcasting window 130 may be viewed in the smaller screen portion. Playing conditions panel 180 is shown to provide the speed and direction of the wind which is important information when playing golf.

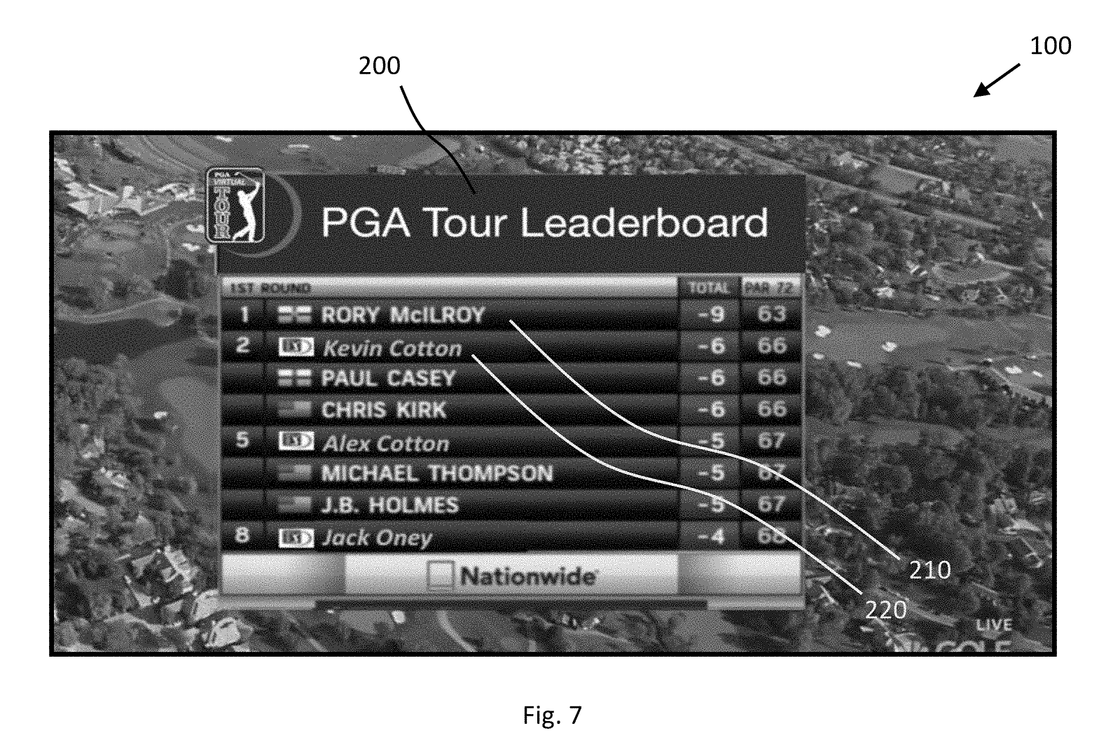

FIG. 7 shows an exemplary virtual leaderboard 200 that combines real PGA players 210 and virtual players 220 to create a truly enhanced viewing and playing golf experience.

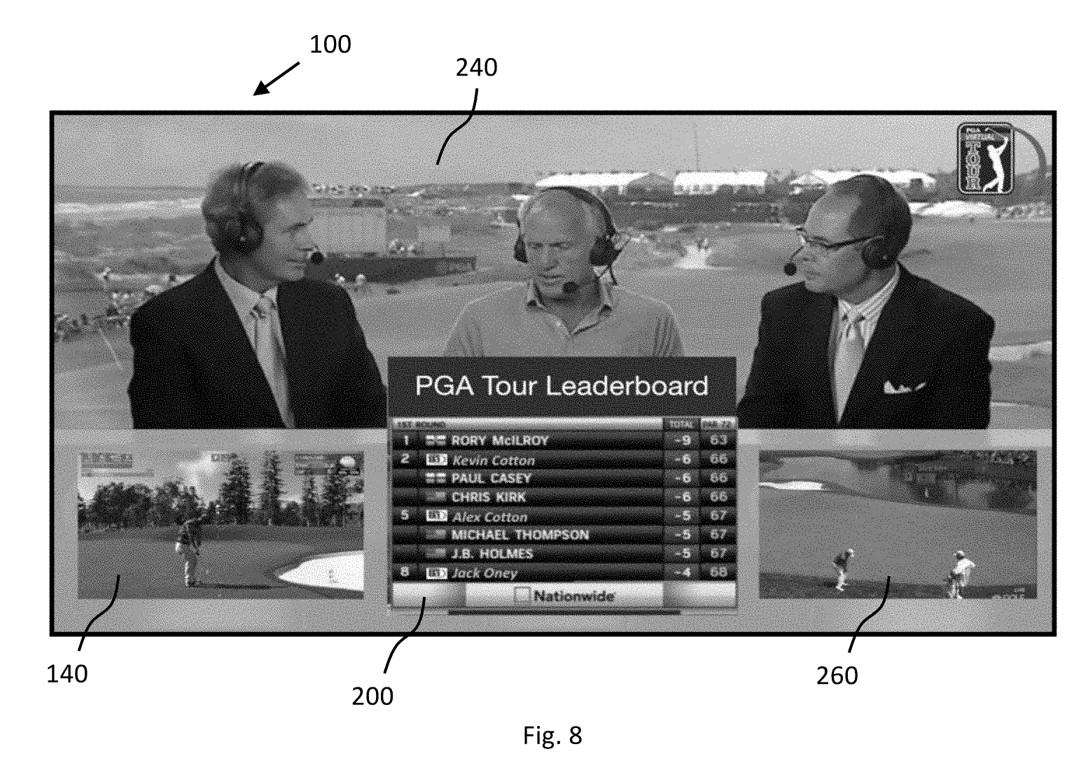

FIG. 8 shows an exemplary layout of multiple screen portions. As is shown, a virtual hole window 140 shows a virtual player hitting a shot. PGA hole window 260 shows a PGA player playing a hole (either same or different hole as being played by virtual player). Virtual leaderboard 200 is also shown as is commonly referred to during a tournament broadcast. Commentator window 240 is also shown wherein TV commentators who routinely discuss the play of the PGA players will also provide commentary on virtual players. This combined commentary provides a truly immersive experience for the virtual players and a stronger appeal to watching the PGA players. This style of combined broadcasting can be appreciated on television, internet and any other media device.

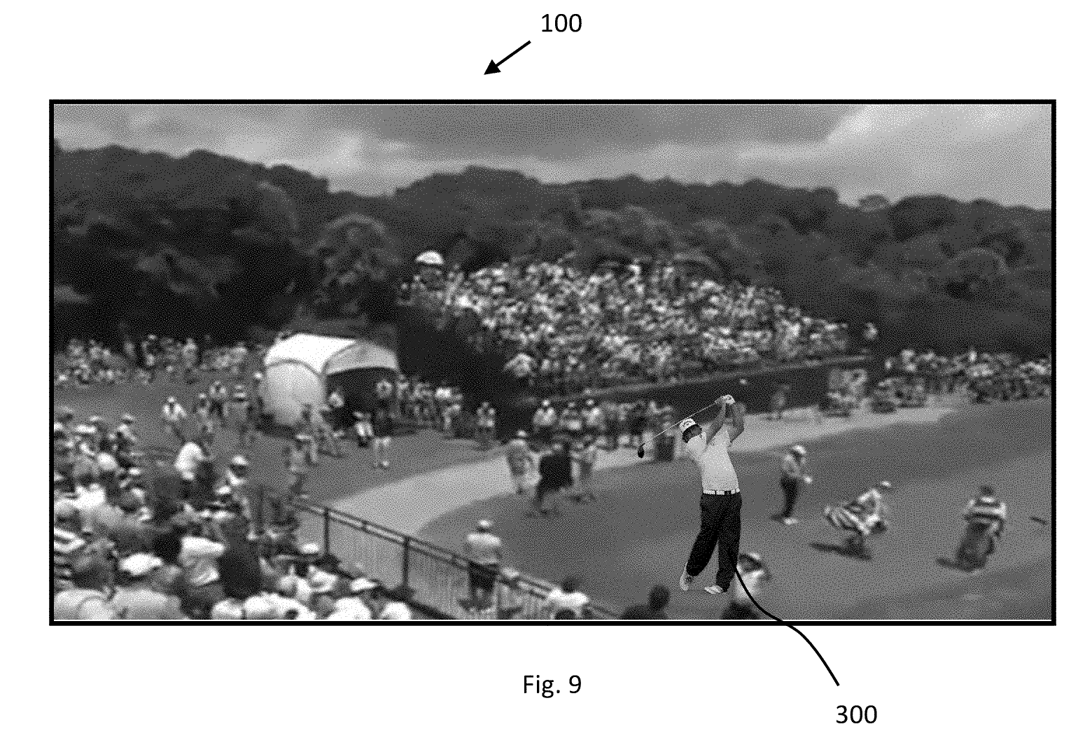

FIG. 9 shows an exemplary combined broadcast of the PGA tournament while also showing a virtual player 300 simultaneously. The virtual player 300 can move about the screen and interact the surroundings. For example, the PGA Tour may pause during the broadcast to allow the virtual player to tee off. Many other virtual-real interactions may be contemplated by one skilled in the art so as to provide a life-like golfing experience.

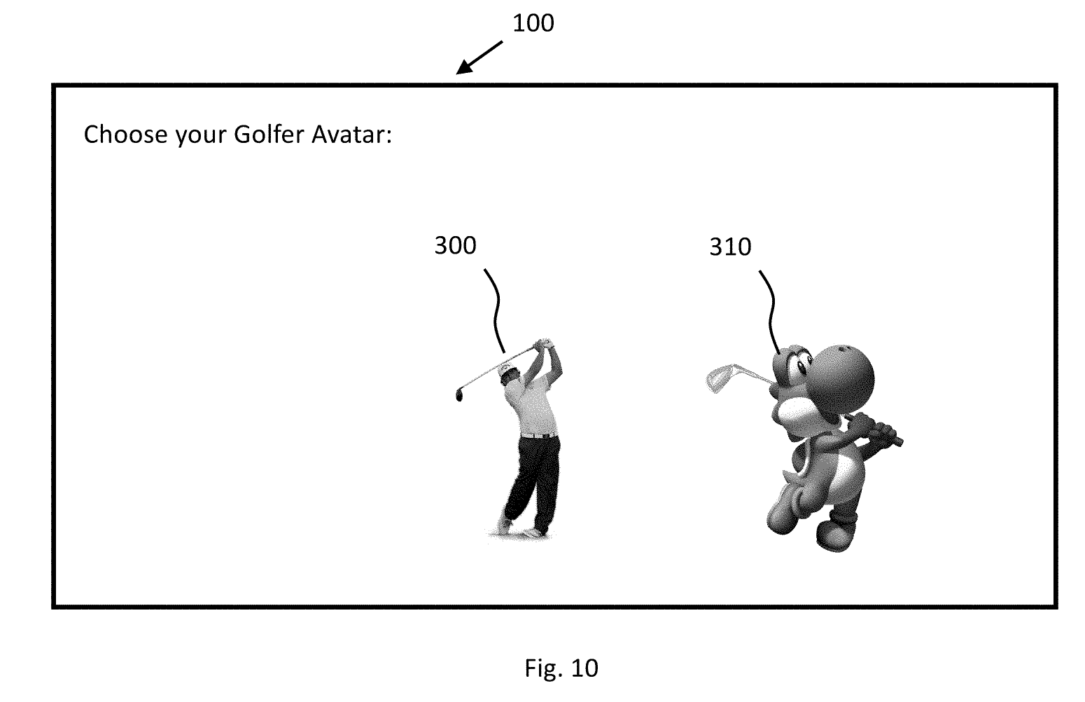

FIG. 10 shows an exemplary group of golfer avatars from which a virtual player may select for the appearance within the game. A first golfer avatar looks more traditional and realistic to a PGA player. A second golfer avatar 310 looks more cartoonish and perhaps more interesting to many gamers. One skilled in the art could imagine a plurality of different avatars that would be appropriate for use in playing golf.

Other game designs and considerations that might make the golfing experience more realistic may include:

(a) In order to qualify for the PGA Virtual Tour, a virtual player would have to go through PGA Virtual Q-School. Just like the regular PGA Tour players have to qualify for the regular PGA Tour, the virtual players might have to qualify. This means all virtual players will be playing 6 rounds on the same course and only the top 50 percent will qualify for the PGA Virtual Tour.

(b) When virtual players are playing, they will be paired in 2-somes, 3-somes or 4-somes just like the PGA Tour and all virtual images will reflect the player's profile. Players will be assigned pairings, for the first 2 rounds and then players that make the cut, will be assigned pairings based on score. If players select to play at their own time, they will be paired accordingly with others players, playing at that time.

(c) The game of the present invention may be further enjoyed by incorporating a gaming swing-device that looks and feels much like a real golf club. Such use of a gaming swing-device is commonly used by the WiiU game console.

(d) PGA Virtual Golfers may receive feedback from the PGA Tour Pros with golf and equipment tips. Such feedback may be based on the brand of club the PGA Virtual Tour Golfer chooses. The feedback may come from the PGA Tour Pros that play the same brand. Feedback may also come from the manufacturer of that brand of clubs as well. Such communications may also include discounts to purchase equipment. PGA Virtual Tour Golfers could also shop the online store attire and equipment—this is all accessible through their gaming console.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

The examples presented herein are intended to illustrate potential and specific implementations. It can be appreciated that the examples are intended primarily for purposes of illustration for those skilled in the art. No particular aspect or aspects of the examples are necessarily intended to limit the scope of the present disclosure.

While various embodiments have been described herein, it should be apparent, however, that various modifications, alterations and adaptations to those embodiments may occur to persons skilled in the art with the attainment of some or all of the advantages of the present disclosure.

What is claimed is:

1. A gaming system for the contemporaneous viewing of a golf broadcast and the virtual playing of the same golf course, comprising:
a player window adapted for the playing of virtual golf by a virtual player;
a broadcast window adapted for the showing of golf being played by a non-virtual player; said player window and said broadcast window being adapted for the contemporaneous playing of the same golf course by the virtual player and the non-virtual player.

2. The gaming system of claim 1, wherein said player window includes a profile panel to enable a virtual player to customize their gaming experience.

3. The gaming system of claim 2, wherein said profile panel includes an apparel window to enable a virtual player to customize the virtual clothes, shoes and the like.

4. The gaming system of claim 2, wherein said profile panel includes a style window to enable a virtual player to customize the swing speed, ball trajectory, draw or fade preferences and the like.

5. The gaming system of claim 2, wherein said profile panel includes a statistics window to enable a virtual player to review their personal stats related fairways in regulation, greens in regulation, average driving distance, putts per round and other like statistics.

6. The gaming system of claim 2, wherein said profile panel includes a statistics window to enable a virtual player to review the stats of the non-virtual player related fairways in regulation, greens in regulation, average driving distance, putts per round and other like statistics.

7. The gaming system of claim 2, wherein said profile panel includes an equipment selection window to enable a virtual player to select type of clubs, brand of clubs, type of balls, compression of balls, woods and lofts for each wood, irons and lofts for each iron, wedges type and lofts for each wedge, putter and loft, and other like equipment options.

8. The gaming system of claim 2, further comprising a playing conditions panel to illustrate the actual playing conditions of the golf course being by the non-virtual player.

9. The gaming system of claim 8, wherein said playing conditions are simulated in the virtual game.

10. The gaming system of claim 1, further comprising a virtual leaderboard that includes the scores of non-virtual players and virtual players.

11. The gaming system of claim 1, further comprising a commentator window wherein a broadcaster comments on the contemporaneous play of the virtual player and non-virtual player.

12. The gaming system of claim 1, further comprising a PGA hole window that shows the broadcast of the PGA golfing tournament.

13. The gaming system of claim 12, further comprising a screen swap button that allows for the swapping of the PGA hole window and a virtual hole window to toggle between a large screen and a small screen within the gaming display.

14. The gaming system of claim 1, further comprising a golf avatar to digitally represent the virtual player within a screen of the contemporaneous broadcast of the non-virtual player.

15. The gaming system of claim 14, further comprising a second golf avatar to digitally represent a second virtual player within a screen of the contemporaneous broadcast of the non-virtual player.
